(19) United States
(12) Patent Application Publication
(10) Pub. No.: US 2015/0373073 A1
(43) Pub. Date: Dec. 24, 2015

(54) IMAGE PICKUP APPARATUS, CONTROL METHOD AND RECORDING MEDIUM

(71) Applicant: CANON KABUSHIKI KAISHA, Tokyo (JP)

(72) Inventor: Mayu Yokoi, Saitama-shi (JP)

(21) Appl. No.: 14/745,201

(22) Filed: Jun. 19, 2015

(30) Foreign Application Priority Data
Jun. 23, 2014 (JP) 2014-128641

(51) Int. Cl. H04L 29/06; H04N 5/232

(52) U.S. Cl. CPC H04L 65/605; H04N 5/23245

(57) ABSTRACT

An image pickup apparatus control method for performing live streaming with a terminal device includes setting an image pickup mode, determining, based on the set image pickup mode, a parameter related to the live streaming, and transmitting the acquired image to the terminal device based on the determined parameter.

### BACKGROUND

1. Field of the Invention

Aspects of the present invention generally relate to an image pickup apparatus where live streaming is performed by transmitting an image picked up by the image pickup apparatus and displaying the image on a terminal device.

2. Description of the Related Art

Regarding live streaming, there is a method for transferring image data using HTTP (Hypertext Transfer Protocol)/TCP (Transmission Control Protocol) which has been used for file transferring. When performing live streaming using this method, a congestion delay is caused due to a network communication condition or device buffering. Further, aspects to be focused on, such as smoothness of the image and image quality, differ depending on an image pickup mode of an image pickup apparatus. In this point of view, Japanese Patent Application Laid-Open No. 2009-89157 discloses that a user can select whether to perform streaming in a high quality mode or to perform streaming in a low-delay mode.

### SUMMARY

Aspects of the present invention are generally directed to an image pickup apparatus for performing live streaming with a terminal device.

An image pickup apparatus according to an aspect of the present disclosure includes a setting unit configured to set an image pickup mode, an image pickup unit configured to pick up an image of a subject based on the image pickup mode set by the setting unit, a determination unit configured to determine, based on the image pickup mode set by the setting unit, a parameter related to live streaming, and a transmission unit configured to transmit, to the terminal device, the image acquired by the image pickup unit based on the parameter determined by the determination unit.

Further features of the present disclosure will become apparent from the following description of exemplary embodiments with reference to the attached drawings.

### BRIEF DESCRIPTION OF THE DRAWINGS

FIG. 1 a diagram illustrating a configuration of a camera.

FIG. 2 a diagram illustrating a configuration of a terminal device.

FIG. 3 a diagram illustrating an overview of live streaming operation in a communication system.

FIG. 4 is a table of parameter priority ratios corresponding to image pickup modes.

FIG. 5 a flowchart describing a process that a CPU of the camera executes after establishing a connection between the camera and the terminal device.

FIG. 6 a flowchart describing a process executed by a CPU of the terminal device after establishing a connection between the camera and terminal device.

FIG. 7 is a diagram illustrating an example of a modification screen of the terminal device, which is used to modify parameters.

FIG. 8 is a diagram of a table indicating an example of a correspondence relation between communication conditions, resolution and frame rates.

### DESCRIPTION OF THE EMBODIMENTS

Hereinafter, exemplary embodiments will be described with reference to the drawings.

### First Embodiment

A communication system according to the present embodiment includes a camera 100 as an image pickup apparatus and a terminal device 200 as an external device which can communicate with the camera 100.

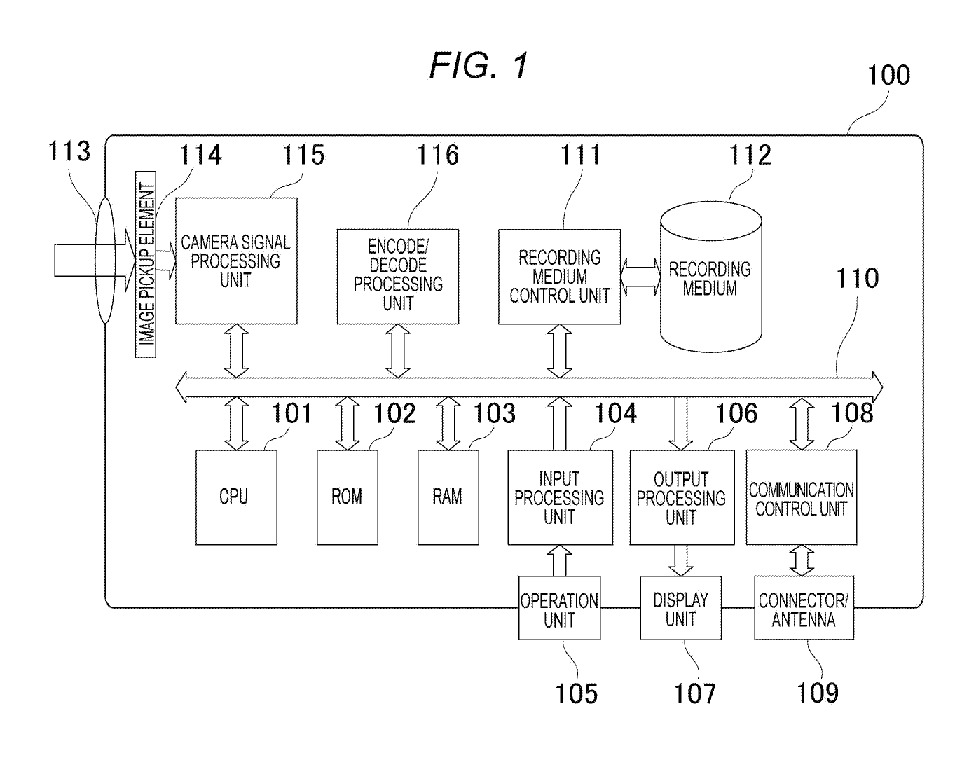

FIG. 1 is a diagram illustrating a configuration of the camera 100.

The camera 100 includes a CPU 101, a ROM 102, a RAM 103, an input processing unit 104, an operation unit 105, an output processing unit 106, a display unit 107, a communication control unit 108, a connector (wired)/antenna (wireless) 109, and an internal bus 110. Further, the camera 100 includes a recording medium control unit 111, a recording medium 112, an optical system 113, an image pickup element 114, a camera signal processing unit 115, an encode/decode processing unit 116 and the like.

The CPU 101, the ROM 102, the RAM 103, the input processing unit 104, the output processing unit 106, the communication control unit 108, the recording medium control unit 111, the camera signal processing unit 115 and the encode/decode processing unit 116 transmit and receive data to and from one another via the internal bus 110.

The ROM 102 stores various programs executed by the CPU 101. Examples of the ROM 102 may include a flash memory. The RAM 103 stores a program, a variable, operation temporary data, and the like that are used when the CPU 101 operates, according to need.

The CPU 101 executes the program stored in the ROM 102 or the recording medium 112 and controls each unit of the camera 100 using the RAM 103 as a working memory.

The optical system 113 is an image pickup lens that includes a focusing mechanism, a stop mechanism, or the like to form an optical image of a subject. The image pickup element 114 is configured to include a CCD or a CMOS element. Here, the image pickup element 114 includes an A/D converter and converts an optical image into an analog electrical signal and then into a digital signal.

According to the control by the CPU 101, the camera signal processing unit 115 executes a resize process (e.g. predetermined pixel interpolation or reduction), a color conversion and various correction processes on the digital signal converted by the image pickup element 114.

According to the control by the CPU 101, the encode/decode processing unit 116 executes compression encoding, on a digital signal processed in the camera signal processing unit 115, in a predetermined format and at a predetermined bit rate, or decodes compression-encoded image data.

Note that, although illustration regarding sound is not included, when the optical system 113 and image pickup element 114 are made as microphones and the display unit 107 is made as a speaker, an audio signal can be handled in a substantially same process. Thus, the sound is recorded at the same time as the image is recorded, and image data including sound can be generated by multiplexing the image and sound in the encode/decode processing unit 116.

The input processing unit 104 receives user's operation on the operation unit 105, generates a control signal corresponding to the operation, and transmits the signal to the CPU 101. For example, the operation unit 105 includes a textual information input device such as a keyboard, a pointing device such as a mouse and a touch panel, or the like, as an input device to accept user's operation. Further, examples of the operation unit 105 include a device that can control remotely, such as an infrared remote control. Here, a touch panel is, for example, an input device designed to output coordinate information corresponding to a touched position on an input unit which is made in a planar shape. This allows to cause the camera 100 to operate according to the user's operation.

The output processing unit 106 outputs a display signal to display data on the display unit 107 based on display data such as a GUI (Graphical User Interface) that the CPU 101 generates by executing a program.

Here, when a touch panel is used as the operation unit 105, the operation unit 105 and the display unit 107 can be integrally formed. For example, the touch panel is formed so that its light transmittance does not interfere with the display of display unit 107 and is installed on an upper layer of the display face of the display unit 107. Then, an input coordinate on the touch panel is associated with a display coordinate on the display unit 107. This realizes a GUI as if the user can directly operate the screen displayed on the display unit 107.

To the recording medium control unit 111, the recording medium 112, such as an HDD, a nonvolatile semiconductor memory, is connected. According to the control of the CPU 101, the recording medium control unit 111 reads data from the connected recording medium 112 and writes data to the recording medium 112. Here, to the recording medium 112 to which the recording medium control unit 111 can be connected, for example, a detachable nonvolatile semiconductor memory, such as a memory card, may be connected via an unillustrated socket.

The recording medium 112 can record information used in the control by the CPU 101, in addition to captured image data.

According to the control of the CPU 101, the communication control unit 108 communicates with the terminal device 200 via the connector/antenna 109. As the communication method, IEEE 802.11 and Bluetooth (registered trademark) which are wireless, IEEE 802.3 which is wired, or the like can be used.

Further, the camera 100 has plural image pickup modes. The present embodiment describes a case where a landscape mode, a sports mode and a portrait mode can be set as the image pickup mode. Here, the image pickup mode is not limited to the above, and other modes may be set according to need. The CPU 101 can set the image pickup mode according to user's operation via the operation unit 105 or according to own judgment based on an image pickup condition.

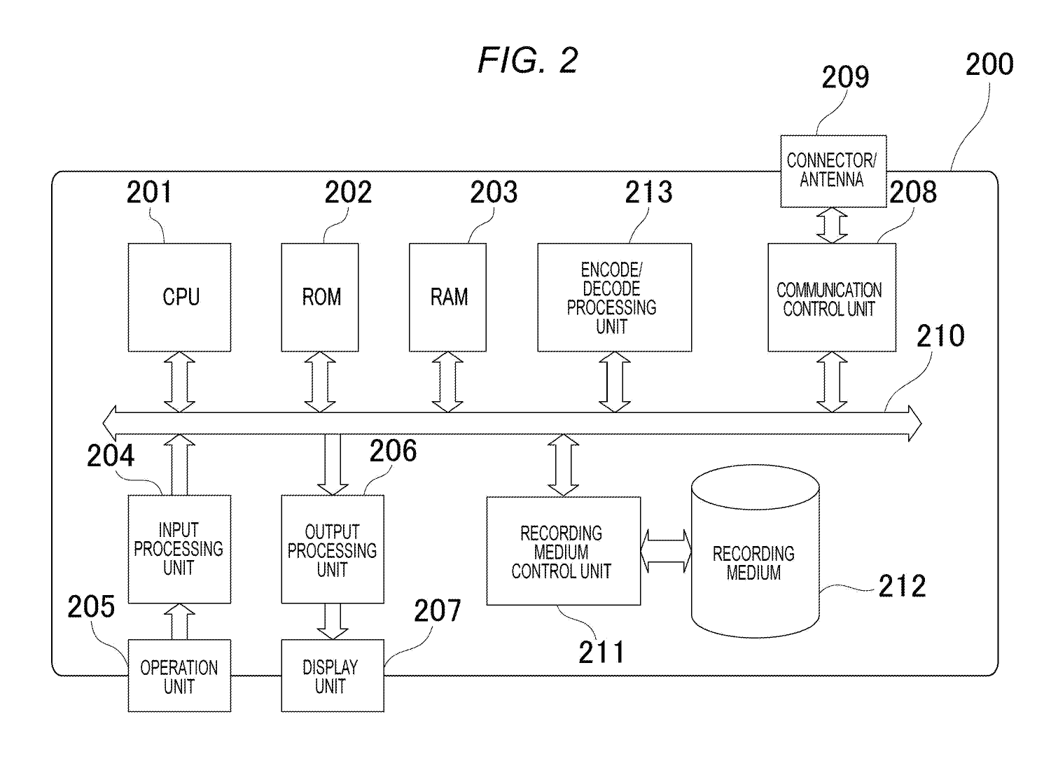

FIG. 2 is a diagram illustrating a configuration of the terminal device 200. The terminal device 200 is an information processing device such as a smartphone and a tablet computer.

The terminal device 200 includes a CPU 201, a ROM 202, a RAM 203, an input processing unit 204, an operation unit 205, an output processing unit 206, a display unit 207, a communication control unit 208, a connector/antenna 209, and an internal bus 210. The terminal device 200 includes a recording medium control unit 211, a recording medium 212, an encode/decode processing unit 213, and the like. In the terminal device 200, the components from the CPU 201 to the recording medium 212 have the same configuration as those in the camera 100 and explanations thereof will not be repeated.

According to the control of the CPU 201, the encode/decode processing unit 213 decodes compression-encoded image data and recodes decoded data according to need.

Next, an overview of operation in the communication system in a case of live streaming using a JPEG (Joint Photographic Experts Group) image frame will be described. Here, the live streaming represents a process of transmitting an image being picked up by the camera 100 and displaying the image by the terminal device 200 as receiving the image data.

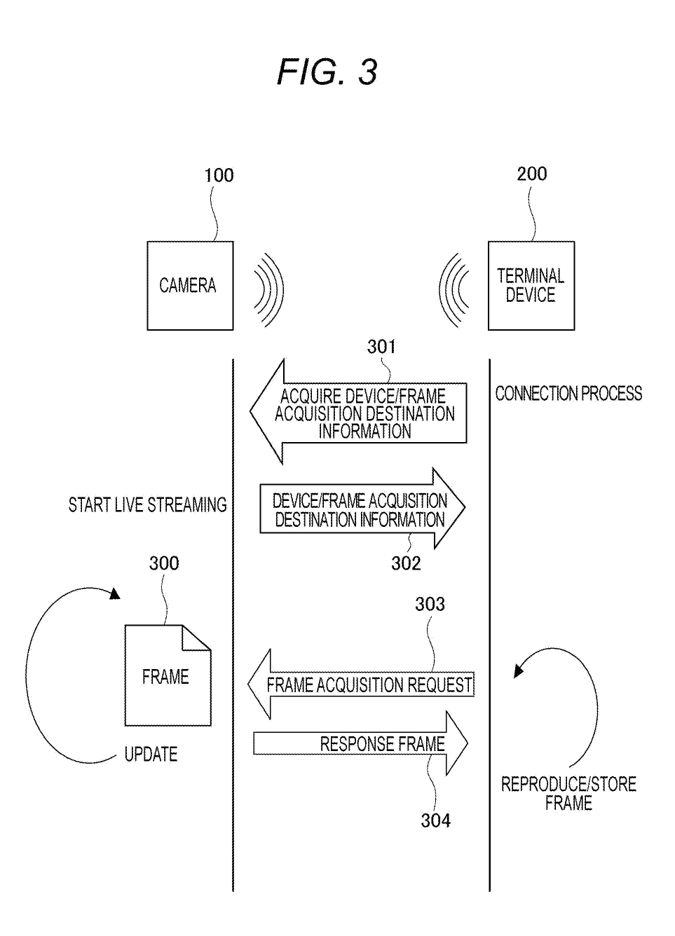

FIG. 3 is a diagram illustrating an overview of live streaming operation in the communication system.

First, when a user of the camera 100 selects a live streaming mode via the operation unit 105, the CPU 101 of the camera 100 controls the communication control unit 108 to be ready for communication. Further, when the user of the terminal device 200 activates an application for the communication connection process and the live streaming via the operation unit 205, the CPU 201 of the terminal device 200 executes a program stored in the ROM 202 or the recording medium 212. Accordingly, the CPU 201 of the terminal device 200 executes a connection process by controlling the communication control unit 208 and starting communication with the camera 100.

Here, it is assumed that the camera 100 and the terminal device 200 use an HTTP (Hypertext Transfer Protocol) as a communication protocol, and are compliant with UPnP (Universal Plug and Play) in a communication connection. When connecting the device to the network, the terminal device 200 compliant with UPnP sets an IP (Internet Protocol) address based on a DHCP (Dynamic Host Configuration Protocol) or AutoIP. After obtaining an IP address, the device searches devices and obtains information such as a type and a service function of a responded device by “Device Discovery and Control” in order to recognize other devices on the network mutually (301 in FIG. 3).

The camera 100 responds with device information and frame acquisition destination information of device-specific information in response to a device search request from the terminal device 200 (302 in FIG. 3).

The connection process between the camera 100 and the terminal device 200 completes and live streaming starts. In other words, the CPU 101 of the camera 100 controls so that the image pickup element 114 starts outputting signals and the camera signal processing unit 115 processes the output into a proper frame 300, and transfers the frame 300 to the encode/decode processing unit 116.

The encode/decode processing unit 116 compresses and encodes the received frame 300 with a predetermined bit and format, and stores the data in the RAM 103 or the recording medium 112. The CPU 101 updates the frame 300 in every predetermined time period T.

The CPU 101 generates path information which is associated with where the frame 300 is stored. The path information is used as acquisition destination information when the terminal device 200 acquires the frame.

The terminal device 200 can acquire the predetermined time period T by previously storing the predetermined time period T or receiving device information of the camera 100 including information of the predetermined time period T.

When approximately T (seconds) passes after live streaming is started, the CPU 201 of the terminal device 200 executes a frame acquisition request (HTTP GET method) (303 in FIG. 3) to the frame acquisition destination which has already been acquired (302 in FIG. 3).

The CPU 101 of the camera 100 transmits the requested frame 300 as a response frame (304 in FIG. 3).

Here, during live streaming, congestion delay may occur at the frame response (304 in FIG. 3). More delay occurs if the image quality is maintained and the image quality has to be lowered to reduce the delay.

The CPU 201 of the terminal device 200 controls to transfer the received frame 300 to the encode/decode processing unit 213 and decode the data, and then controls to reproduce and display the data on the display unit 207 via the output processing unit 206. When a recording instruction from the user of the terminal device 200 is given via an application, the CPU 201 of the terminal device 200 stores, in the recording medium 212 via the recording medium control unit 211, the decoded data or a data part that is the frame 300 from which a header and the like are removed. In this example, the CPU 201 of the terminal device 200 combines and registers the frames which are sequentially received.

During the live streaming, the CPU 101 of the camera 100 updates frames every approximately T (seconds), and deletes the already acquired frames. The CPU 201 of the terminal device 200 executes a frame acquisition request every approximately T (seconds) (303 in FIG. 3).

Here, a unique ID of the terminal device 200 or the application is attached to the frame acquisition request from the terminal device 200. The camera 100 executes live streaming in response to the request of the first requested ID. In other words, live streaming is executed between the camera 100 and the terminal device 200 only in a one by one connection.

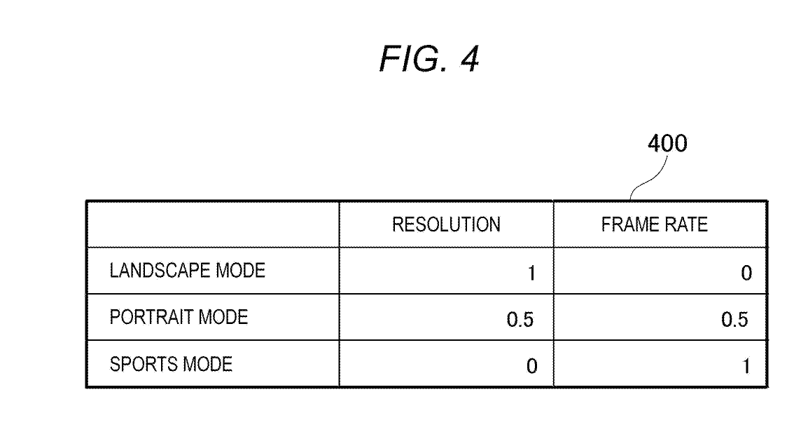

Next, in the present embodiment, when live streaming is being executed, the camera 100 transmits frames, that is the image, to the terminal device 200 after determining a parameter related to the live streaming (hereinafter, simply referred to as a parameter) corresponding to the image pickup mode. FIG. 4 is a table of parameter priority ratios corresponding to the image pickup modes.

Here, a case where the image pickup modes are the above-described landscape mode, portrait mode, and sports mode will be described. Further, a case where the parameter represents resolution and a frame rate will be described. The parameter priority ratio is from zero to one, and one represents the highest priority and zero represents the lowest priority.

Here, the landscape mode is an image pickup mode to pick up an image of a subject which makes fewer movements in general by fixing the camera 100 to a pan head or placing the camera 100 on a fixed place. Thus, in the case of the landscape mode, the image quality needs to be improved to pick up a fine and beautiful image rather than picking up a smooth image. Thus, as indicated in FIG. 4, the priority ratio between the resolution and the frame rate is made 1:0.

Further, the sports mode is an image pickup mode to pick up an image of a subject that makes movements, or pick up a smooth image by a remote control. Thus, in the case of the sports mode, a smooth image is preferred rather than an improved image quality. Thus, as indicated in FIG. 4, the priority ratio between the resolution and the frame rate is made 0:1.

In other words, the landscape mode sets a higher resolution and a lower frame rate compared to the sports mode, and the sports mode sets a lower resolution and a higher frame rate compared to the landscape mode. That is, between the landscape mode and the sports mode, the relation of the resolution and the frame rate is opposite from one another.

Further, the portrait mode is an image pickup mode which is in the middle of the landscape mode and the sports mode. In other words, the priorities of the image quality and the image smoothness are taken almost equally. Thus, as indicated in FIG. 4, the priority ratio between the resolution and the frame rate are made 0.5:0.5.

A table 400, as in FIG. 4, which indicates the association between the image pickup modes and the parameter priority ratios is recorded in the ROM 102 of the camera 100, for example.

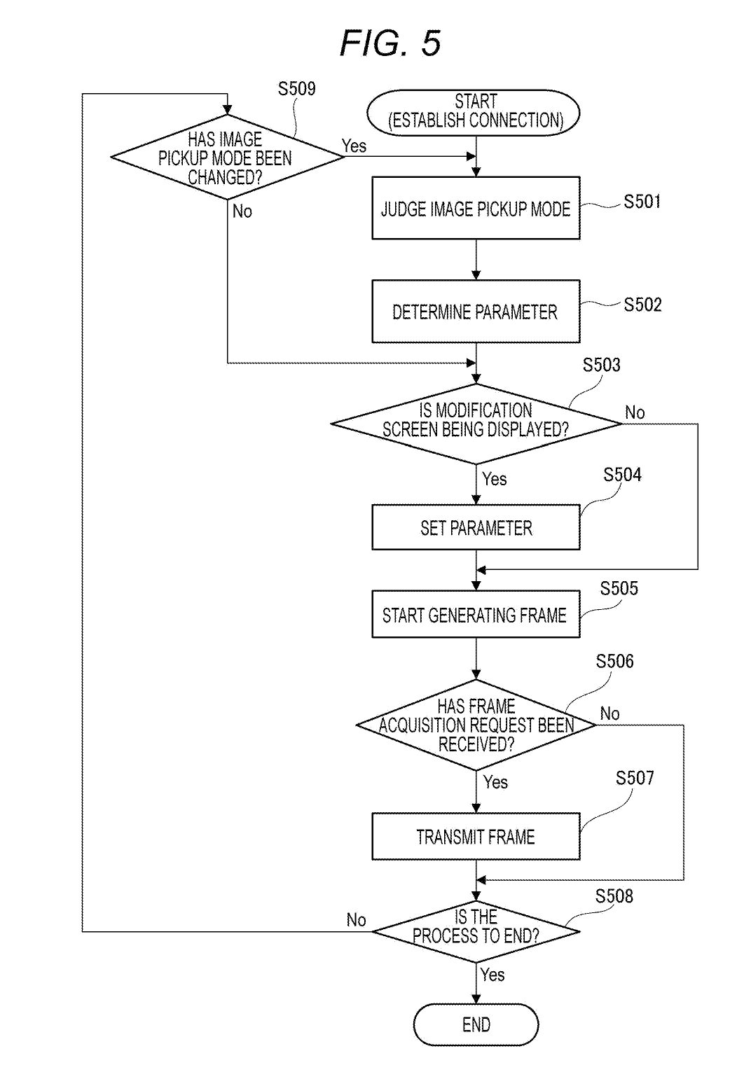

Next, a process that the CPU 101 of the camera 100 executes after establishing a connection between the camera 100 and the terminal device 200 will be described with reference to a flowchart of FIG. 5.

In step S501, the CPU 101 judges an image pickup mode set during live streaming. Here, it is assumed that there are three modes: landscape mode, the sports mode, and the portrait mode.

In step S502, the CPU 101 determines a parameter based on the judged image pickup mode. Specifically, by referring to the table 400 of FIG. 4, which is recorded in the ROM 102, the CPU 101 acquires the priority of the resolution and the frame rate corresponding to the image pickup mode. Next, the CPU 101 determines values of the resolution and the frame rate based on the acquired priority. In the present embodiment, there are four levels of resolution which are “1920×1080 (dots),” “1440×1080,” “1280×720”, and “640×360” in descending order. Further, there are three levels of frame rates which are 60 fps, 30 fps and 15 fps in descending order.

For example, when the landscape mode is set, the CPU 101 determines, based on the priority ratio of 1:0, the resolution as the highest value of “1920×1080” and the frame rate as the lowest value of 15 fps. Further, for example, when the sports mode is set, the CPU 101 determines, based on the priority ratio of 0:1, the resolution as the lowest value of “640×360” and the frame rate as the highest value of 60 fps. Further, for example, when the portrait mode is set, the CPU 101 determines, based on the priority ratio of 0.5:0.5, the resolution as the medium value of “1440×1080” and the frame rate as the medium value of 30 fps. Here, the CPU 101 determines the higher resolution of “1440×1080” between the medium resolutions of “1440×1080” and “1280×720”. The CPU 101 transmits the determined values of the resolution and the frame rate to the terminal device 200 as initial values.

In step S503, the CPU 101 judges whether or not a modification screen for modifying the values of the resolution and the frame rate is being displayed on the display unit 207 of the terminal device 200. For example, the CPU 101 can judge it based on whether or not a notification of displaying a modification screen is received from the terminal device 200. When the modification screen is being displayed, the process proceeds to step S504. When the modification screen is not being displayed, process proceeds to step S505.

In other words, in the present embodiment, although the initial values of the parameter are determined in step S502, the user of the terminal device 200 can modify parameters to preferred ones using the modification screen.

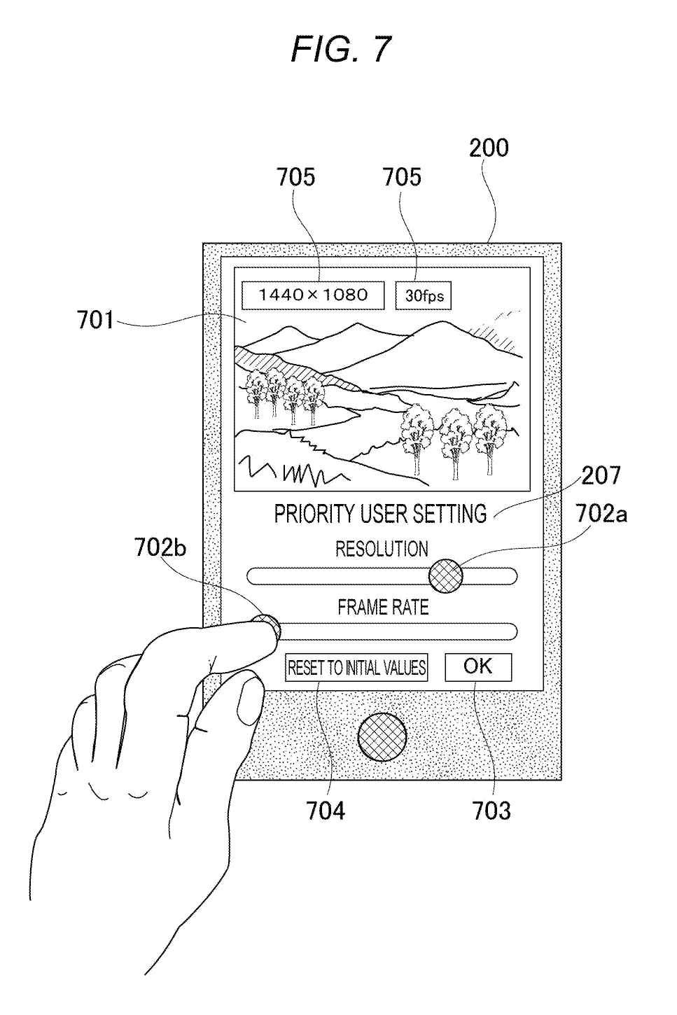

FIG. 7 is a diagram illustrating an example of the modification screen of the terminal device 200, which is used to modify parameters.

The terminal device 200 illustrated in FIG. 7 has a configuration in which the operation unit 205 and the display unit 207 are integrally formed. In FIG. 7, while the CPU 201 displays the image data received from the camera 100 on a region 701 of the display unit 207, scroll bars 702a and 702b that allow to modify the resolution and the frame rate, a completion button 703, a reset button 704, and the like are also displayed. When the user of the terminal device 200 shifts the scroll bars 702a and 702b to preferred positions and presses the completion button 703, the CPU 201 determines the values of the resolution and the frame rate to the modified values.

The CPU 201 displays the current values of the resolution and the frame rate on regions 705 of the display unit 207. Here, when the reset button 704 is pressed, the CPU 201 resets the positions of the scroll bars 702a and 702b so as to indicate the initial values of the resolution and the frame rate at the time of being received from the camera 100.

Here, the CPU 201 transmits, to the camera 100, the values of the resolution and the frame rate at the time when the completion button 703 is pressed.

In step S504, the CPU 101 modifies and sets the values of the resolution and the frame rate to the values received from the terminal device 200.

In step S505, the CPU 101 generates a frame to start live streaming. The CPU 101 controls so that the image pickup element 114 starts outputting signals and the camera signal processing unit 115 processes the output into proper image data and transfers the data to the encode/decode processing unit 116. The encode/decode processing unit 116 starts a process of compressing and coding the received image data in a predetermined bit rate and format. In this case, the CPU 101 controls the image pickup element 114 and the camera signal processing unit 115 to acquire image data with the resolution and the frame rate which are set in step S504.

In step S506, the CPU 101 judges whether or not a frame acquisition request has been received from the terminal device 200. When a frame acquisition request has been received, the process proceeds to step S507. When a frame acquisition request has not been received, the process proceeds to step S508. In this case, the terminal device 200 transmits a frame acquisition request in a cycle where the frame rate becomes equal to the frame rate which is set when a frame is received in step S504.

In step S507, the CPU 101 transmits a frame to the terminal device 200 in response to the frame acquisition request.

In step S508, the CPU 101 judges whether or not to end the process. When ending the process, the process related to the live streaming is ended. When the process is not ended, the process proceeds to step S509.

In step S509, the CPU 101 judges whether or not the image pickup mode has been changed. The change of the image pickup mode may be made when the CPU 101 changes the mode based on user's operation via the operation unit 105 or judges and changes based on the image pickup condition on purpose.

Here, when the values of the resolution and the frame rate are set in the values received from the terminal device 200 in step S504, the CPU 101 may keep the values of the resolution and the frame rate even if the image pickup mode is changed, considering the will of the user of the terminal device 200. Further, even when the values of the resolution and the frame rate are set in the values received from the terminal device 200 in step S504, a new parameter based on the image pickup mode may be determined if the CPU 101 has changed the image pickup mode based on the user's operation.

When the image pickup mode has been changed, the process proceeds to step S501. When the image pickup mode has not been changed, the process returns to step S503.

Here, in the flowchart of FIG. 5, a case where the steps to judge events are processed in order of steps S503, S506, and S509 has been described; however, the embodiment is not limited thereto. When the respective events are judged at the same time, the respective processes may be executed in order of occurrence of the events.

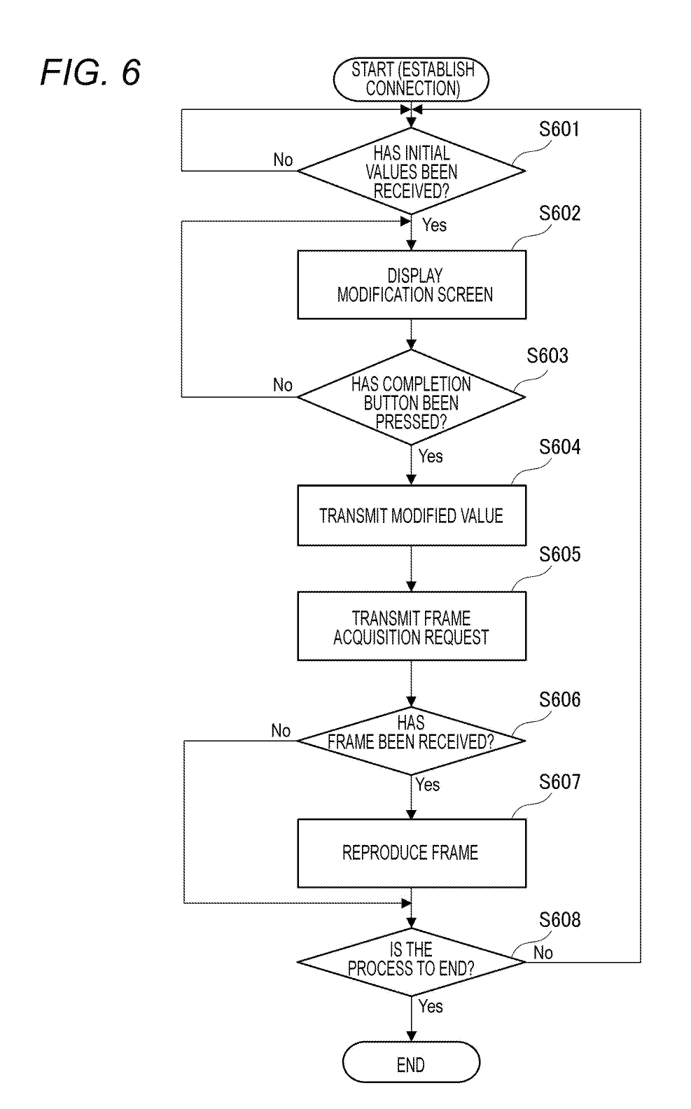

Next, a process executed by the CPU 201 of the terminal device 200 after establishing a connection between the camera 100 and terminal device 200 will be described with reference to a flowchart of FIG. 6.

In step S601, the CPU 201 judges whether or not values of the resolution and the frame rate have been received from the camera 100 as initial values. When the values have been received, the process proceeds to step S602. When the values have not been received, the CPU 201 stands by.

In step S602, the CPU 201 displays a modification screen in which values of the resolution and the frame rate received from the display unit 207 are indicated as the scroll bars. Subsequently, the CPU 201 notifies the camera 100 that the modification screen is being displayed. Here, since the modification screen of the display unit 207 is described above related to FIG. 7, the explanation will not be repeated.

In step S603, the CPU 201 judges whether or not the user has pressed the completion button 703. When the completion button 703 has been pressed, the process proceeds to step S604. When the completion button 703 has not been pressed, the process returns to step S602.

In step S604, the CPU 201 determines the modified values as the values of the resolution and the frame rate, and transmits the values to the camera 100. Here, when the completion button 703 is pressed without modifying the values, the initial values received from the camera 100 are transmitted. Further, the CPU 201 stores the determined values of the resolution and the frame rate in the RAM 203.

In step S605, the CPU 201 transmits a frame acquisition request to the camera 100. In this case, the CPU 201 transmits a frame acquisition request in a cycle where the frame rate becomes equal to the frame rate which is determined when the frame is received.

In step S606, the CPU 201 judges whether or not a frame is received from the camera 100. When a frame has been received, the process proceeds to step S607. When a frame has not been received, the process proceeds to step S608.

In step S607, the CPU 201 displays the obtained frame on the region 701 of the display unit 207. Here, since the frames are transmitted from the camera 100 in a cycle corresponding to the frame rate in response to the frame acquisition requests, the CPU 201 can display the frames on the display unit 207 at the frame rate determined in step S604.

In step S608, the CPU 201 determines whether or not to end the process. When ending the process, the process related to the live streaming is ended. When not ending the process, the process returns to step S601.

As described above, according to the present embodiment, when an image being picked up by the camera 100 is displayed on the terminal device 200 by live streaming, a parameter corresponding to the image pickup mode of the camera 100 is determined before transmitting data to the terminal device 200. Thus, the terminal device 200 can display an image corresponding to the image pickup mode.

### Second Embodiment

In the first embodiment, a case where parameters are determined depending solely on the image pickup mode has been described. In the present embodiment, a case where a parameter is determined considering a communication condition as well will be described. Here, since each components of a camera 100 and a terminal device 200 and each flowchart are the same as those in the first embodiment, the explanation thereof will not be repeated.

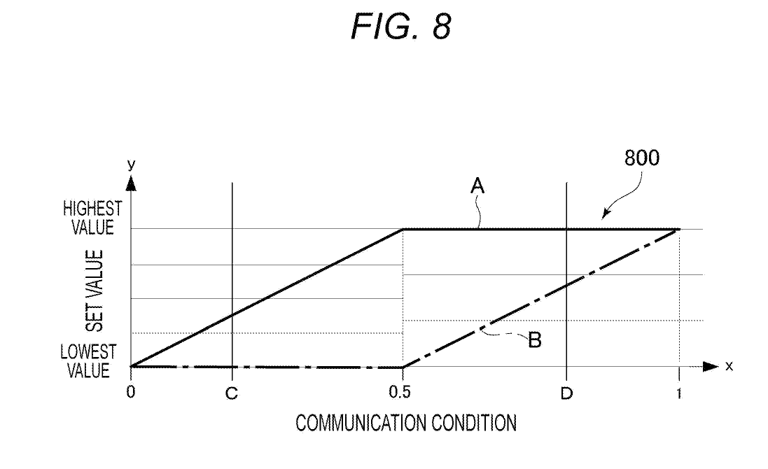

FIG. 8 is a diagram of a table indicating an example of a correspondence relation between communication conditions, resolution and frame rates. In FIG. 8, the X-axis represents the communication conditions and the Y-axis represents values of the resolution and the frame rate.

The communication condition is judged by a CPU 101 of the camera 100 or a CPU 201 of the terminal device 200 based on a transfer rate. Here, the communication condition is represented as “0” in a case of a lowest transfer rate in the communication system and “1” in a case of a highest possible transfer rate. Thus, for example, in a case of a middle transfer rate between the lowest transfer rate and the highest possible transfer rate, the communication condition is represented as “0.5”.

In FIG. 8, in a landscape mode, a continuous line A represents resolution and a chained line B represents frame rates. On the other hand, in a sports mode, the continuous line A represents frame rates and the chained line B represents resolution.

Here, in a range where the communication condition is from 0 to 0.5, the continuous line A increases proportional to the communication condition and the chained line B is kept indicating the lowest value. On the other hand, in a range where the communication condition is from 0.5 to 1, the continuous line A is kept indicating the highest values and the chained line B increases proportional to the communication condition.

For example, when the communication condition is at the position C in the landscape mode, the resolution is “1280×720” and the frame rate is 15 fps. Further, when the communication condition is at the position D in the landscape mode, the resolution is “1920×1080” and the frame rate is 30 fps. Here, the values of the resolution and the frame rate corresponding to the communication conditions do not have to be represented by straight lines, such as the continuous line A and chained line B in FIG. 8, and may be represented by curved lines.

A table 800 that shows association between communication conditions and parameters as illustrated in FIG. 8 is recorded in the ROM 102 of the camera 100, for example.

The judgment of the communication condition is executed only once after establishing the connection between the camera 100 and the terminal device 200. Specifically, it is preferable to judge the communication condition when the CPU 101 of the camera 100 judges the image pickup mode in step S501 illustrated in FIG. 5. Here, when the CPU 201 of the terminal device 200 judges the communication condition, the communication condition information is transmitted to the camera 100. By referring to the table 800 of FIG. 8, the CPU 101 of the camera 100 can determine values of the resolution and the frame rate corresponding to the communication condition.

Here, the judgment of the communication condition is executed only once in order to prevent a situation where the processes become complicated as those values are modified even when the communication condition is deteriorated temporarily. However, when a predetermined communication condition continues for a certain period of time, the CPU 101 of the camera 100 may newly determine the resolution and the frame rate.

As described above, according to the present embodiment, when displaying an image being picked up by the camera 100 on the terminal device 200 by live streaming, a parameter is determined based on the communication condition in addition to the image pickup mode before transmitting data to the terminal device 200. Thus, the terminal device 200 can display an image corresponding to the image pickup mode and the communication condition.

The above-described embodiments are not seen to be limiting and any combination is seen to be covered by the scope of the embodiments.

The above embodiments describe a case where the camera 100 transmits frames in response to frame acquisition requests from the terminal device 200, but are not limited thereto. For example, the camera 100, without the frame acquisition requests from the terminal device 200, may transmit frames until an end instruction from the terminal device 200 is received.

The above embodiments describe a case where the camera 100 controls the image pickup element 114 and the camera signal processing unit 115 so that the frame rate becomes equal to the frame rate set in step S504, but are not limited thereto. For example, when the terminal device 200 transmits a frame acquisition request in every cycle where the frame rate becomes equal to the one set in step S504, the camera 100 may use a frame rate higher than the one set in step S504.

Further, the above embodiments describe a case where the user of the terminal device 200 can modify the values of a parameter, but are not limited thereto. The camera 100 may determine a parameter depending on the image pickup mode (and a communication condition) and transmit frames to the terminal device 200 based on the determined parameter without a modification.

While the above embodiments describe a camera, the embodiments are not limited thereto. The above-described embodiments can be applied to other equipment, such as a Personal Digital Assistant (PDA), mobile phone, a portable image viewer, digital photo frame, music player, game machine, or an electronic book reader, which includes an image pickup unit and can communicate with the terminal device 200.

### Other Embodiments

Additional exemplary embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-128641, filed Jun. 23, 2014, which is hereby incorporated by reference herein in its entirety.

What is claimed is:

1. An image pickup apparatus that performs live streaming with a terminal device, the image pickup apparatus comprising:
a setting unit configured to set an image pickup mode;
an image pickup unit configured to pick up an image of a subject based on the image pickup mode set by the setting unit;
a determination unit configured to determine, based on the image pickup mode set by the setting unit, a parameter related to the live streaming; and
a transmission unit configured to transmit, to the terminal device, the image picked up by the image pickup unit based on the parameter determined by the determination unit.

2. The image pickup apparatus according to claim 1 further comprising
an acquisition unit configured to acquire a communication condition between the image pickup apparatus and the terminal device,
wherein the determination unit determines, depending on the image pickup mode set by the setting unit and the communication condition acquired by the acquisition unit, the parameter related to the live streaming.

3. The image pickup apparatus according to claim 1, wherein
the image pickup mode includes a first image pickup mode and a second image pickup mode,
the determination unit determines at least a first parameter and a second parameter as the parameter related to the live streaming, and
a value of the first parameter in the first image pickup mode is greater than a value of the first parameter in the second image pickup mode, and a value of the second parameter in the first image pickup mode is less than a value of the second parameter in the second image pickup mode.

4. The image pickup apparatus according to claim 3, wherein
the first parameter represents resolution,
the second parameter represents a frame rate, and
wherein the determination unit determines higher resolution and a lower frame rate when the first image pickup mode is set, and determines lower resolution and a higher frame rate when the second image pickup mode is set.

5. The image pickup apparatus according to claim 3, wherein
the first image pickup mode is a mode to pick up an image of a subject which makes fewer movements, and
the second image pickup mode is a mode to pick up an image of a subject which makes more movements.

6. The image pickup apparatus according to claim 3, wherein
the first image pickup mode includes a mode to pick up a landscape images and the second image pickup mode includes a mode to pick up sports scene images.

7. The image pickup apparatus according to claim 1, further comprising
a change unit configured to change the parameter related to the live streaming determined by the determination unit to a parameter received from the terminal device.

8. An image pickup apparatus control method for performing live streaming with a terminal device, the method comprising:
setting an image pickup mode;
determining, based on the set image pickup mode, a parameter related to the live streaming;
picking up an image based on the image pickup mode; and
transmitting the picked up image to the terminal device based on the determined parameter.

9. A computer readable recording medium storing computer executable instructions that cause a computer to execute an image pickup apparatus control method for performing live streaming with a terminal device, the method comprising:
setting an image pickup mode;
determining, based on the set image pickup mode, a parameter related to the live streaming;
picking up an image based on the image pickup mode; and
transmitting the picked up image to the terminal device based on the determined parameter.
